(19) United States
(12) Patent Application Publication
(10) Pub. No.: US 2020/0082348 A1
(43) Pub. Date: Mar. 12, 2020

(54) METHOD OF REDUCING EMPLOYER HEALTH RELATED COSTS WHILE PROMOTING EMPLOYEE WELLNESS AND HEALTH BENEFIT PLAN STRATEGY FOR SAME

(71) Applicant: Douglas J. Short, Thonotassa, FL (US)

(72) Inventor: Douglas J. Short, Thonotassa, FL (US)

(21) Appl. No.: 16/683,668

(22) Filed: Nov. 14, 2019

Related U.S. Application Data
(63) Continuation of application No. 15/172,731, filed on Jun. 3, 2016.
Application No. 15/172,731 is a continuation of application No. 13/031,645, filed on Feb. 22, 2011, now abandoned.
Application No. 13/031,645 is a continuation of application No. 11/326,763, filed on Jan. 6, 2006, now abandoned.
Application No. 11/326,763 is a continuation-in-part of application No. 10/950,245, filed on Sep. 24, 2004, now abandoned.
Application No. 10/950,245 is a continuation-in-part of application No. 10/652,849, filed on Aug. 29, 2003, now abandoned.
(60) Provisional application No. 60/506,096, filed on Sep. 25, 2003.
(60) Provisional application No. 60/486,846, filed on Jul. 11, 2003.
(60) Provisional application No. 60/493,758, filed on Aug. 8, 2003.

(51) Int. Cl. G06Q 10/10; G06Q 10/00; G06Q 50/22; G06Q 99/00; G06Q 40/08

(52) U.S. Cl. CPC G06Q 10/1057; G06Q 10/00; G06Q 40/08; G06Q 99/00; G06Q 50/22

(57) ABSTRACT

In an effort to reduce employer health insurance related costs, at least one benefit under a health benefit plan is conditional on the employee voluntarily participating in a wellness program. The wellness program could include wellness categories such as a tobacco free category, normal blood pressure category, regular exercise category, a non-overweight category, a healthy cholesterol level category, a healthy blood glucose level category, and possibly even a category for participation in a health risk assessment. The invention may be implemented by an employer adopting a health plan with a higher deductible over a previous year, and providing credits against that deductible for employees who satisfy requirements regarding each of a variety of wellness categories. This should enable the employer to realize an immediate savings in the year that the invention is implemented, and future savings in years thereafter from healthier employees having lesser numbers of claims and smaller dollar claims.

### RELATION TO OTHER APPLICATIONS

This application is a continuation of Ser. No. 15/172,731, filed Jun. 3, 2016 which is a continuation of Ser. No. 13/031,645 filed Feb. 22, 2011 which is a continuation of Ser. No. 11/326,763 filed Jan. 6, 2006 which is a continuation-in-part of Ser. No. 10/950,245, filed Sep. 24, 2004, which claimed the benefit of provisional application 60/506,096, filed Sep. 25, 2003, and is a continuation-in-part of application Ser. No. 10/652,849, filed Aug. 29, 2003 with the same title which claimed the benefit of provisional patent applications 60/486,846 and 60/493,758, filed Jul. 11, 2003, and Aug. 8, 2003, respectively.

### TECHNICAL FIELD

The present invention relates generally to reducing employer health coverage costs while providing incentives to promote wellness in a group of employees, and more particularly to health coverage strategy with benefits contingent upon an employee adopting aspects of a healthy lifestyle, such as refraining from tobacco usage.

### BACKGROUND

A variety of strategies have been tried by various employers over the past years in an effort to reduce healthcare associated costs for their employees. For instance, some employers have tried a cost shifting strategy by requiring employees to pay a portion of the premiums for their health insurance. In other cases, employees are given choices to tailor a health insurance product to suit their individual needs, such as a high deductible, whereas another employee can choose a different set of benefits at a different contributory cost. In other attempts to control costs, employers provide wellness programs to their employees in the hopes of reducing future healthcare costs. Unfortunately, in many instances the persons most in need of changing to a healthier lifestyle are the last ones to take advantage of employer provided wellness programs. In other instances, employers adopt strategies that may reduce costs in the long run, but only by increasing costs in the short run. For instance, wellness programs that reward healthy behavior will result in immediate increases in employer costs, with only likely reductions later if the rewards achieve healthier employees with lower cost of claims and lesser numbers of claims.

There are also tax consequences to consider. Under current law, an employer can financially reward employees that adopt a healthier lifestyle by maintaining a weight within certain healthy parameters, maintaining an acceptable blood pressure level, and not smoking, etc. outside of an insurance product. However, these financial incentives would be considered as taxable compensation to the employee under the current tax code. In other words, the value of the financial incentive should appear on an employee's W-2 tax statement at the end of the year, with both the employee and employer paying taxes regarding that benefit. On the other hand, the tax code provides for health plan benefits to be both tax deductible by the employer and non-taxed compensation to the employee. Thus, while financial rewards for adopting healthier lifestyles can potentially reduce healthcare costs in the long term, these gains can be offset by additional tax burdens for both employer and employee.

The present invention is directed to reducing employer costs in the short and long runs while providing a financial incentive to adopt a healthier lifestyle without increasing a tax burden on either the employer or employees.

### SUMMARY OF THE DISCLOSURE

A method of providing health coverage to a group of employees includes a step of covering employees under a group health insurance policy with a predetermined deductible. An employee is provided with a credit that reduces the deductible if the employee satisfies a predetermined criteria associated with a wellness category.

### BRIEF DESCRIPTION OF THE DRAWINGS

FIG. 1 is a graph of employer costs, and cost of claims before and after an employer has implemented the invention of the present disclosure.

### DETAILED DESCRIPTION

In one aspect, the present invention includes a state-governed fully-insured supplemental health coverage that is provided by an employer to a group of employees. The actual insurance coverage is provided by an insurance company in a conventional manner. Those skilled in the art will appreciate that a supplemental plan provides coverage that supplements, but does not substitute for, coverage provided under a core health insurance plan, which may be either state governed or ERISA governed. Under current tax laws, the health insurance coverage is treated as non-taxable compensation to the employee, but treated as a tax deductible expense for the employer. The term “state-governed” is intended to mean a health plan that is governed by one or more of the individual states of the United States, as opposed to an ERISA (Employee Retirement and Income Security Act) based health benefit plan that is governed under federal law. From another perspective, the supplemental health benefit plan can be characterized as compliant with non-discrimination rules (hereafter HIPAA compliant health benefit plan) HIPAA instead of being characterized as “state governed”. Some employers provide a core health benefit plan that is both state governed and nondiscriminatory, as provided by law. The term “fully-insured” is a term of art in the insurance industry meaning generally that in exchange for premium payments, which would be paid at least partially by the employer, coverage according to the insurance contract is provided for insured employees. A person can be fully insured and still have an obligation to make partial premium payments or co-payments for benefits and still have certain limitations on the scope of coverage, namely limitations on specific diseases or conditions for which coverage is afforded, and limitations on the treatment regimens authorized. While federal law prohibits virtually any health benefit plan from discriminating in virtually any way in coverage provided to employees, state-governed fully-insured supplemental and other HIPAA compliant health benefit plan have no such restriction. It is this aspect of state-governed and/or HIPAA compliant health benefit supplemental plans that help enable the present invention. As a consequence, if the state-governed supplemental health benefit plan covers a group of employees in more than one state, at least the administrator of the policy would have to become licensed in each such state according to the laws and rules of that individual state in order to administer the state-governed supplemental health benefit product. On the other hand, a HIPAA compliant health benefit plan is best characterized by its ability to discriminate without violating general HIPAA rules prohibiting discrimination. A bonafide wellness program might fall into this category.

The present invention recognizes that healthier employees will reduce employer costs by statistically having less and smaller healthcare related claims. However, the present invention also recognizes that, in many or most instances, it is individual decisions and behavior that serve to improve one's health. The present invention seeks to provide an incentive for individuals to make healthier lifestyle choices. In a preferred version of the present invention, these incentives are financial but some might also be best categorized as withholding a penalty for making healthier lifestyle choices. In this regard, the present invention recognizes that a dollar spent to create an incentive for a healthier lifestyle for an individual can reap many dollars in potential savings via a lesser number of, and likely a smaller value for, health care claims that the individual may make in the future. In addition, these gains can also be leveraged by the fact that, on average, healthier employees are more productive than less healthy employees.

Under the present invention, the state-governed fully-insured health supplemental benefit plan that an employer provides for their employees includes at least one conditional benefit under the plan that is conditioned on the employee's voluntary participation in a wellness program. A wellness program includes, but is not limited to one or more of wellness categories, wellness education, disease inoculation, targeted illness screenings, and injury prevention. The wellness categories could include, but are not limited to a tobacco free category, a normal blood pressure category, a non-overweight category, a cholesterol category, a blood glucose category, a Health Risk Assessment category and a regular exercise category. Wellness education might include, but is not limited to, stress management education, relaxation techniques instruction, smoking cessation programs, weight loss programs, an exercise program, a food nutrition program, education in understanding blood draw measurements, self-defense instruction and many others known in the art. A disease inoculation aspect of a wellness program could include an annual flu shot or some other inoculation known in the art. An injury prevention aspect of a wellness program could include features such as wearing seatbelts when a passenger' in a motor vehicle, not smoking within one's home or motor vehicle, or having smoke detectors installed in one's home, and many other known steps that can decrease the likelihood of a future injury. A wellness program under the invention is voluntary, in that the employee is free to decide on participation or not. In other words, participation is in no way mandated by the employer. However, a benefit may be conditioned on voluntary participation in a wellness program. For instance, a benefit(s) may be conditioned on voluntarily submitting to a blood draw and consenting to testing of the blood, or other bodily fluid or matter (e.g. hair).

Another aspect of a voluntary wellness program could potentially include illness screenings to detect certain identified targeted illnesses. Assuming that disease specific limitations may one day become available in core health benefit plans, this aspect of the invention could be implemented. This aspect of the invention recognizes that the magnitude of a healthcare claim necessary to make a person well can be greatly influenced by the stage of the identified illness when treatment begins. For instance, many cancers, such as breast cancer and colon cancer, can be effectively and successfully treated at a relatively low cost if the cancer is detected early. Thus, a state-governed fully-insured supplemental health benefit plan, or virtually any plan at a future time, according to the present invention might condition coverage, or a portion thereof, for an identified illness on whether the claimant took advantage of an illness screening for that identified illness before or contemporaneously with detection of the identified illness. For instance, an employee who has regular screenings for breast cancer according to a schedule suggested by the American Cancer Society would receive full coverage for any breast cancer related claim that might occur. On the other hand, an employee who refrains from screening tests for breast cancer but later requires treatment for a relatively advanced case of breast cancer might have a higher deductible for a breast cancer related claim or might receive limited or no coverage for a breast cancer based claim. In another instance, an employee might be rewarded under the supplemental policy by voluntarily participating in a blood draw. The information from the blood testing could indicate a pre-diabetic condition that could be turned around with knowledge of the condition and by taking actions associated with healthy lifestyle changes. But the employee needs to know of the unhealthy biometric before they can consciously act to improve the condition. Those skilled in the art will appreciate that there are a wide variety of potential illnesses that can be screened against, and new screening tests for different illnesses are often being introduced. For example, illness screenings could include cancer screens, heart disease screens, abnormal vision screens, abnormal orality screens, mental illness screens, blood or genetic illness screens, screening for high cholesterol or high blood glucose levels, and a wide variety of other screening tests known in the art. In a preferred version of the present invention, the supplemental health benefit plan would provide coverage to pay for the screening tests that are intended to detect certain identified illnesses early so that the same can be treated successfully and at a relatively lower cost. This could be done by making up for a high deductible in the core plan with a benefit from the supplemental plan.

Thus, a voluntary wellness program according to the present invention can, and likely would, come in a wide variety of forms suited to a particular employee population. On one hand, an employee that chooses to remain tobacco free, has a normal blood pressure, is not overweight, regularly exercises, has good cholesterol levels has healthy blood glucose levels, is screened for certain identified illnesses on a prescribed frequency, and engages in a variety of other healthy lifestyle choices would receive the maximum benefits available under the employer provided state-governed fully-insured supplemental health benefit plan. On the other hand, it might be better characterized as the identified persons getting the least penalty under a healthcare program for having healthy lifestyles and biometrics. Thus, an overweight employee who does not exercise, has high blood pressure and smokes, has high cholesterol, high glucose levels, avoids any illness screenings and engages in a variety of other unhealthy lifestyle choices would receive minimal coverage under the employer provided supplemental health benefit plan. But both employees would receive the same coverage under the core health benefit plan provided by the employer. Thus, the present invention seeks to shift the risks that drive the costs of healthcare to those persons whose individual decisions produce the risk of healthcare claims, but in no way mandates participation in any wellness program.

While employers may opt to provide only a state-governed fully-insured health benefit plan for their employees, many current employers provide health benefit, coverage under an ERISA governed health benefit plan, both core plan strategies presently prohibit any activity regarded as discriminatory against one or more of the employees relative to others under Federal HIPAA laws and regulations. Those employers might opt to incorporate the present invention by increasing a deductible on their current ERISA governed or state governed core, health insurance plan, and purchase a new state-governed fully-insured supplemental health benefit plan to conditionally cover the deductible increase. In other words, an employee who fully qualifies at the initiation of the new health benefit plan to participate in all of the defined wellness program may see no difference in their present net health insurance coverage. On the other hand, employees who do not participate in the new wellness program will obtain no benefits under the state-governed supplemental or HIPAA compliant health benefit plan and thus will continue coverage only under the ERISA or state governed core plan, but they will experience a higher deductible. Thus, implementation of the invention can be thought of as adding one or more penalties associated with one or more wellness categories with regard to an individual employee's deductible, and withholding those penalties if the employee qualifies for those wellness categories. Withholding a penalty is a subtle but important difference from rewarding healthy biometrics and lifestyle behaviors, since withholding a penalty can permit immediate savings to the employer, even in the first year of implementing the present disclosure.

In one example, an employer might currently offer an ERISA governed healthcare plan that provides for a $500.00 deductible. Those skilled in the art will appreciate that ERISA governed health benefit plans cannot, by law, discriminate against any employees for any reason. When the present invention is implemented, the employer raises the deductible to $2500.00 per person and allows for five wellness categories. Among these are 1) weight within a healthy range (BMI), 2) blood pressure within a healthy range, 3) non-tobacco usage 4) cholesterol levels in healthy range, and 5) healthy blood glucose levels. For each of these categories the employee would be granted a $400.00 deduction credit under a state-governed fully-insured or HIPAA compliant health benefit plan to be applied against their deductible expense. For instance, if they are a nonsmoker and they maintain health cholesterol levels, they would qualify for $800.00 of deduction credits to be spent toward their $2,500.00 deductible. An employee that qualifies for all five wellness categories would realize no change, or a $500.00 deductible, in the year the invention is implemented. Should they not qualify for any of the wellness categories described, the employee will absorb a larger deductible.

Clearly there would need to be criteria to each of these wellness categories. For instance, it might be desirable to provide verifiable standards, or it may operate on an honor system, or a combination of both. For instance, weight might be verified on a periodic basis by merely stepping on the scales and comparing the employees weight to what their weight should be under certain height and weight guidelines (body mass index), such as National Health Institute standards. On the other hand, whether the employee engages in regular exercise could be merely on an honor system without any substantial verification.

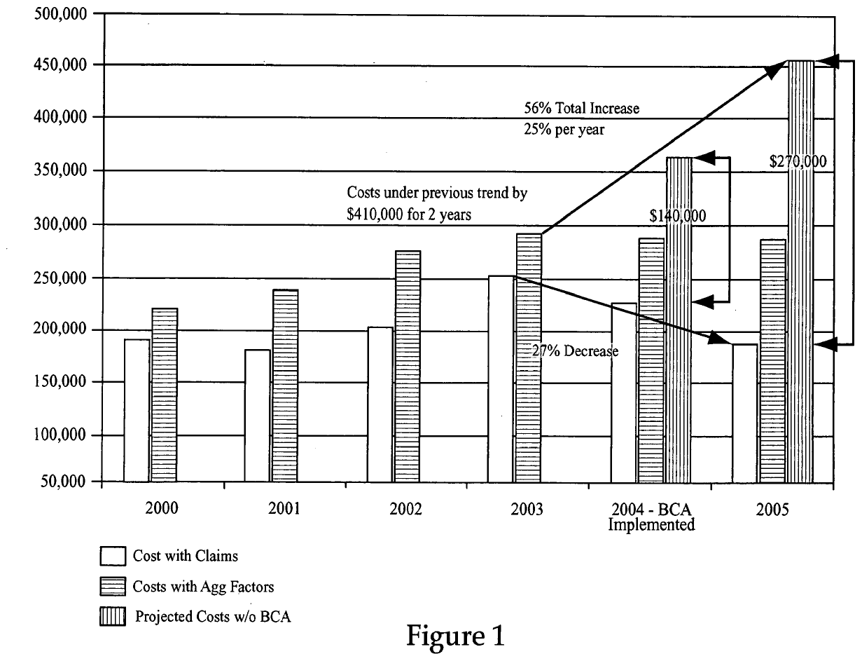

If we further explore the above example, the carrier will reduce the employer's aggregate funding requirements or premium costs, giving a one to one savings against all claims spent between the $500.00-$2500.00 example yielding a net savings to the plan. In other words, by raising the deductible from $500.00 to $2500.00, the premiums for the policy will drop in the first year, and this drop multiplied by the number of employees can amount to a substantial savings. However, a portion of this savings will be cancelled out by employees who do qualify for wellness categories. FIG. 1 shows an example trend in an employer's health care costs along with claim costs before and after implementing the present invention. In particular, over the years 2000 to 2003, there is a steady but increasing pressure on employer health care costs when their plan remains unchanged. In addition, the cost of claims are increasing. In the year 2004, the employer implements the present disclosure by raising their deductible and setting up wellness categories for employees to gain credits back against the deductible increase. By doing so, the employer's health care costs slightly decreased or remained the same in 2004 rather than experiencing a double digit percentage increase as reflected by the vertically hatched bar in 2004. One more surprising observation of the present invention was an immediate decrease in claim costs after implementing the invention. This reflects two features of the invention. First, some employees may not be aware of an unhealthy condition, such as high blood glucose levels or high cholesterol, and may be motivated to take action to reduce those potentially unhealthy biometrics simply by gaining knowledge about the same. Second, employees will be motivated to obtain the deduction credits associated with having those biometrics in a healthy range. As claim costs drop and eventually level out at a lower level, the employer can request reduced premiums, and the insurance carrier can lower premiums without a reduction in profits, which are roughly estimated by the difference between employer's costs (horizontal hatching) and claim costs (no hatching). One might expect, for example, about 40% of the people qualifying for all five wellness categories. The remaining employees might qualify for some variation of the five and therefore save the corporation the difference. The incentives provided under this strategy could progress to incentives for dependents as well, but employees would be a good starting point.

In the plan above, each category provides an identical fixed dollar amount which is additive to each other category in a linear fashion. Alternative programs can be designed that are more sophisticated, providing either different deduction credits for different categories, or a non-linear relationship among deduction credits, or both. For example the increase in deduction credits for not smoking could be $500, while the increase in deduction credits for low cholesterol might alternatively be $300, with the remaining categories having conditional deduction credits of $400. These could be additive, as outlined above. Even more sophisticated non-linear relationships can be implemented, where, for example, for a person meeting all wellness criteria they would have a $2000 credit, but if a person failed to meet just one of the wellness criteria, they would only have a $1000 credit, and if they failed to meet two of the wellness criteria, they would have only a $400 credit, and if they failed to meet three or more of the wellness criteria, they would have no credit toward the deductible.

If a person is maintaining a healthy lifestyle, this will have a beneficial effect on the health insurance plan losses, and will likely hasten an employee's recovery time after illness or surgery. If the employee does not participate, they would qualify for a higher deductible under the core health benefit plan.

One should also keep in mind that every dollar currently spent on healthcare, between a current employee's deductible and the carrier's specific threshold deductible is all employer money in the case of a self funded plan. The incentive provided by the present invention would help to control the expense of that fund. Further, if employees do not participate in the wellness incentives, their deductible or out-of-pocket healthcare expenses will be commensurate with their lifestyle choices. While at least two of the currently planned biometrics, body mass index and blood pressure, can be measured without testing bodily fluids, several of the remaining wellness categories, such as an indicator of tobacco usage, cholesterol levels, and blood glucose levels, might be tested via a blood draw from the participant, such as an employee and/or dependent. Because so much useful information can be gained by measuring biometrics of an employee from a blood sample, including those that are different from that wellness categories described above, an employer may condition participation in any deductible credits on an employee's voluntarily permitting a blood draw. Thus, even if an employee appears to have a healthy body mass index and supposedly does not use tobacco, that employee may not be eligible for any wellness deductible credits if they do not voluntarily submit to a blood draw. In order to leverage the information gained by a blood draw, the employer might provide instruction regarding employee actions that can move an unhealthy biometric in a proper direction, and provide other education regarding the meaning of the biometrics revealed by the blood draw.

The unique opportunity to categorize participants is found only by a new relationship. Presently, it is generally not possible to categorize employees under any other system except a bonafide wellness program excepted from the HIPAA discrimination prohibition, and maintain the tax advantages. In the case of state governed supplemental health benefit plans, there are very few health coverage administration companies that are licensed to administer both an ERISA based health plan and a state-governed supplemental medical reimbursement plan seamlessly in all or most states. An employee would likely never see the separation of the two structures provided by the core plan and the separate wellness credits. Keep in mind, they would always (by law) get two checks. However, all claims would be handled as a single claim submission, as it is currently done.

In order to potentially be an administrator of such a health benefit plan strategy, an administrator would likely need to become licensed to administer both self funded and fully-insured plans in almost every state in the country. Furthermore, that administrator would likely need to secure contracts with fully-insured carriers around the country that would compliment their existing clients. Thus, the present invention can marry a discriminatory State licensed fully-insured supplemental incentive program to an existing Federally license, non-discriminatory core health plan to create unique savings for both employer and employees.

In another aspect of the invention, which may be permissible under a bonafide wellness program or other program excepted from HIPAA discrimination prohibitions, an employer provides only a single fully-insured healthcare benefit plan (which could alternatively be self-funded) for covering their group of employees. Certain benefits (wellness credits) under that policy would be contingent upon an employee participating in a wellness program that might include certain wellness categories, such as those described above. For instance, an employee who participated in regular exercise, refrained from smoking, maintained a healthy body mass index, had healthy cholesterol levels, had healthy blood glucose levels, and maintained a normal blood pressure, would receive the maximum amount of benefits (wellness credits) available under the policy. Another employee who participated in none of the wellness categories might receive some healthcare benefits or might have to pay a much higher deductible under the plan due to their lifestyle choices. A healthy employee who refuses to have their biometrics measured may not get any wellness credits, as these benefits may be conditioned on the employee voluntarily permitting a blood draw. In other words, under the present invention, those who take steps to maintain wellness through a healthier lifestyle will be rewarded with the maximum coverage under a healthcare policy by having the most penalties withheld from them. Whereas, those who choose riskier behaviors, such as smoking, will have to pay a proportionally higher portion of their healthcare costs due to the decreased amount of benefits (higher deductible) afforded to them under the employer's policy. Thus, in this alternative, no dual health benefit plan is required, but a change in the law would likely be needed in order to implement this aspect of the invention unless the plan can be made compatible with a bonafide wellness exception provided under HIPAA. Instead, the employer simply provides one state-governed fully-insured plan, or possibly a future or currently available ERISA based plan, that includes a variety of benefits that are contingent upon the employee engaging in certain healthy lifestyle choices.

In another aspect of the invention, identifiable populations in an employee work force can be targeted to potentially reduced long term healthcare costs. For instance, certain benefits under the supplemental or HIPAA compliant health benefit plan could be contingent upon women employees over a certain age having regular mammogram screenings. In another example, the population of men over age forty (40) could be targeted by conditioning certain benefits under their supplemental healthcare benefit plan upon them taking regular prostate screenings to detect prostate cancer. In both of these instances, the employee would be rewarded (or penalty withheld) for making healthy lifestyle choices that include screening for certain illnesses and diseases when they can be detected and treated relatively inexpensively and effectively. For instance, in the case of prostate cancer, the supplemental or HIPAA compliant health benefit plan might specifically exclude or severely limit coverage for prostate cancer if the employee fails to obtain prostate screening tests on the schedule prescribed by the plan, which could incorporate recommendations by the American Cancer Society.

Another employer may choose a wellness program that includes targeted illness screenings. This aspect of the invention recognizes that the costs associated with screenings for certain illnesses can substantially reduce potential claims for those illnesses in the future. In other words, many illnesses can be treated successfully and at a relatively low cost if caught early. Thus, the state-governed fully-insured supplemental or HIPAA compliant health benefit plan might include coverage for preventative healthcare such as certain targeted illness screenings, but severely limit or exclude additional coverage for those illnesses if the employee fails to take advantage of an illness screening according to a prescribed schedule that may be included in the plan. The prescribed schedule would likely be different for different illnesses and may be based on established norms, such as various screening procedures and frequencies suggested by the American Cancer Society. Those skilled in the art will recognize that many illnesses can be screened for, and these screening tests are often relatively inexpensive with new procedures being introduced every year. If this aspect of the present invention were incorporated into an employer's wellness program, the state-governed fully-insured supplemental health benefit plan could, and likely would need to be, updated on a yearly basis to reflect advances in illness screening technology and techniques. An employer might improve this aspect of the invention by taking steps to make screening test opportunities more available to employees through a variety of techniques known in the art.

In another aspect of the present invention, an employer might include wellness education participation and possibly even voluntary public service as conditions for certain benefits under a state-governed fully-insured or HIPAA compliant health benefit plan. For instance, the employee might receive a financial credit to be applied against any healthcare claims for each wellness education course that employee attends. These wellness education courses could include everything from self-defense instruction to nutrition instruction. This aspect of the invention recognizes that providing individuals with the knowledge of how to make healthier lifestyle choices will increase the likelihood that the employee will actually make those healthier lifestyle choices. Again, healthier lifestyle choices will, on average, result in a lesser number of, and smaller dollar amount value for, healthcare related claims. An employer can further leverage this aspect of the invention by, for instance, offering wellness education programs on company property during convenient times, such as during lunch hours or immediately following the end of a shift, or at any other time and place that is convenient to employees.

An employer might also choose a wellness program that includes disease inoculation and/or injury prevention aspects according to the present invention. For instance, a disease inoculation aspect of the present invention might allow for the state-governed fully-insured or HIPAA compliant health benefit plan to pay for flu shots, or the employer might provide flu shots outside of the policy at a convenient time and place for employees. However, doctor visits in the same year that are due to flu would be excluded from additional coverage provided by plan if that employee refused a flu shot earlier in the year. An injury prevention aspect of the present invention might limit medical payments for injuries received in a motor vehicle accident if the employee was without a seat belt at the time of the injury. In another application, the state-governed fully-insured supplemental health benefit plan may decrease a net deductible for a claim resulting from fire injuries in an employee home having smoke alarms. Those skilled in the art will appreciate that, depending upon the type of condition applied, that a wide variety of administrative techniques and verifications could be utilized to process claims that may be subject to a conditional benefit.

In still another aspect of the invention, the cost savings afforded by the basic invention can be leveraged by an employer taking other actions. For instance, while the present invention provides an incentive to maintain wellness, an employer can also provide opportunities to improve wellness. For instance, an employer might consider providing an exercise area and/or equipment on company property for employee use. In another example, an employer might have blood pressure testing equipment and/or weight scales distributed throughout the corporate property to afford employees the opportunity to monitor their wellness in regard to weight and blood pressure. One could expect that by providing opportunities for healthy lifestyle choices and providing an incentive to adopt healthier lifestyle choices, an employer could expect a symbiotic relationship between these two strategies for reducing healthcare costs.

In one aspect, an employer would provide employees with health insurance coverage under two separate health insurance policies, core and supplemental. The first policy would look much like the health insurance policies currently provided by most employers in that it would be a group insurance policy governed federally under ERISA. This first policy might have a relatively high deductible. The second health insurance policy would be a fully-insured supplemental policy governed by each of the individual States, and would have discriminatory features not permitted by ERISA governed plans. For instance, the second policy could provide coverage for a substantial portion, if not all, of the gap created by the deductible for the ERISA governed health policy. However, benefits under the second policy would be conditional on an employee satisfying certain wellness conditions through participation in a wellness program. For instance, a fraction of the deductible for the first policy could be covered under the second policy if the employee were to maintain a certain height and weight ratio or body mass index. Another fraction would be conditioned upon the employee refraining from tobacco usage. A third fraction might be conditional upon an employee maintaining a certain blood pressure level. Other categories might require a blood draw, such as a biometric relating to cholesterol and/or blood glucose levels. Still another fraction could be conditional upon the employee engaging in regular exercise. Such a strategy would provide an expanded range of healthcare coverage for employees who engage in a healthy lifestyle, whereas employees who do not engage in a healthier lifestyle are still insured under the ERISA governed health insurance policy, but must absorb the costs themselves for the higher deductible. Because both the conditional and non-discriminatory aspects of the health insurance strategy are provided via health insurance products, the benefits are neither taxable to the employees nor the employer, and the employer may take a tax deduction for all the premium costs associated with both health insurance products.

In still another application of the present invention, the reward (or withholding of a penalty) for participation in a wellness program could go toward an employee's share of their health insurance premiums on an employer provided ERISA based or state governed core health insurance plan. In other words, when implementing the invention, an employer would add a fully-insured state-governed supplemental health insurance plan or HIPPA compliant health benefit plan to cover his employees with at least some of the benefits being contingent upon employee participation in a wellness program. The conditional benefits could include payment of a portion of that employee's share of premiums for the core health insurance plan provided by the employer to cover the employees. In a specific example, an employee might be required to pay one fourth of a health insurance premium for that employee under an employer provided core health care plan. When the invention is implemented, the fully-insured state-governed supplemental health insurance plan added for covering employees might include a $50.00 per month credit to be applied to that employee's share of the core plan premiums for participation in each of four or more different wellness categories, including a non tobacco usage category, a healthy BMI category, healthy cholesterol levels, healthy blood glucose levels, a healthy blood pressure range category, a regular exercise category and possibly even participation in a Health Risk Assessment questionnaire. Implementing this aspect of the invention may not be permissible under current law, but may be available in the future. Thus, when transitioning from before the invention to a year that includes the invention, an employee who participates in all of the wellness categories might actually have no out of pocket obligation for paying a portion of their core plan based premiums, which would instead be paid as a conditional benefit under the state-governed fully-insured or HIPAA compliant health benefit plan package. Those who do not participate in any of the wellness categories, may see no change in either their paycheck or their health insurance coverage when transitioning to the new program.

In another example application, an employer may announce an increase in the share that employees will have to pay in subsequent years for premiums on health insurance coverage under a core plan provided by the employer. However, these increases would be offset by premium credits paid by a new fully-insured state-governed or HIPAA compliant supplemental health benefit plan contingent upon participation in a wellness program. For instance, an employee who fully participates in all wellness categories might experience no change in either their paycheck or the magnitude of their health insurance coverage from before application of the invention to the years following. On the other hand, an employee who participates in no aspect of the wellness program would receive no premium credits and would have to absorb the premium share increase on the core plan themselves. By noticing a substantial change in their paycheck each pay period, it is believed that the employees making poor health decisions will be motivated to make healthier wellness decisions. Thus, the present invention contemplates rewards from the state-governed or HIPAA compliant supplemental health benefit plan being able to fit in a number of different categories, including for payment of premiums on a ERISA or state government core plan. For credits to be applied against deductibles on the core plan, and possibly even an increase in a lifetime benefit offered under a health benefit plan.

In the example illustrated previously regarding the partial payment of core plan premiums as a contingent benefit from a state-governed supplemental health benefit plan, the employer could expect a net savings. While the cost of the added benefit plan would increase expenses, there would be an immediate and greater savings on the part of the employer for those premium payments that have been shifted to employees who do not participate in the wellness program. In addition, like compound interest, the up front savings would continue in the future, and would build upon themselves via the wellness program such that future health care claims would likely be less in number and smaller in magnitude. In time, this would allow for a reduction in premiums as the population of insured employees becomes healthier and at a lower risk of healthcare claims.

Apart from the wellness categories described above, another might be participation in a health risk assessment. Typically this involves an employee answering a variety of questions related to lifestyle, family health history and other related health matters that allow the employee's risk of developing certain health care related problems to be assessed. When an employee has good information regarding a potential health care risk that can be avoided, they are more likely to make appropriate lifestyle changes that will reduce the health problem risk. Thus, the present invention recognizes that by participating in a health risk assessment, an employee will be armed with knowledge that they can use to make themselves healthier, and thus avoid or reduce future claims. It has been reported that as much as 70% or more of health care related costs are attributable to lifestyle choices. Even without a potential financial benefit, many employees are likely to take healthier action simply by being provided with knowledge of where their respective risks lay. And healthy changes are further more likely if the employee is provided with knowledge regarding what action they can take to reduce those risks. Thus, in another aspect of the present disclosure, one reward under the invention, or another withheld penalty such as a deduction credit, would be conditioned upon the employee participating in a health risk assessment.

The present disclosure also recognizes that some employers may be reluctant to adopt a wellness program and change the health care coverage they provide to their employees unless they can achieve some immediate savings, or at least hold the line on costs in the year that the new plan is adopted. Instead of rewarding employees for participation in a wellness program, this aspect of the invention withholds a penalty(s) against those who participate in the wellness program. This aspect of the invention is particularly applicable to cases in which the employer adopts a new plan that raises the deductible for all employees (the penalty) in the year that the new plan is adopted. However, employee participation in a variety of different wellness categories will earn credit offsets against the deductible increase (withholding of the penalty). Provided that the deductible increase is sufficiently large, the employer could expect the policy premiums to drop or at least remain steady in the year that the plan is adopted. This results in an immediate savings to the employer, and thus a large incentive to proceed with adopting a new plan according to the present disclosure.

FIG. 1 shows a typical trend that an employer could expect with or without adopting a plan according to the present disclosure. The plan according to the present invention is adopted in the year 2004, and reflects a slight decrease in the employer health care costs. On the other hand, if the plan according to the present invention is not adopted, the employer could expect double digit increases in health care costs in each successive year for the foreseeable future. Thus, the deductibility increase provides the employer with immediate relief. In addition, this graph shows that, as expected, the cost of claims is driven downward after the new plan is implemented due to several factors. Among these factors are a motivation on the part of employees to adopt healthier lifestyles, and providing employees with information, such as blood draw results, that enable them to identify and act upon unknown health care issues, such as blood pressure, blood glucose levels and cholesterol levels. While the downward trend in claims costs could expect to level out sometime in the future, the initial downward trend allows for increased insurer profits while also possibly permitting a reduction in premiums in future years. Thus, an employer adopting a plan according to the present invention could expect immediate savings and a downward pressure on costs for years to come after the plan is adopted, whereas other employers can only expect double digit increases compounding year after year in their health care costs. In addition to the reduction in health care costs, the quality of life for the employees and their families may well be significantly improved. Employee absenteeism may well be reduced, and productivity increase.

In still another embodiment of the present invention, there is an insight regarding the effects of persistent participation in a wellness program. In other words, sustained participation in a wellness program can continue to reduce the risk of, and magnitude of, health related claims by that individual with time. For instance, a person who refrains from tobacco usage for one year will decrease their likelihood of getting lung cancer; however, the same person will have a substantially lower risk of getting lung cancer if they sustain their tobacco abstention for five years continuously. This ever dropping risk due to sustained wellness can provide another avenue for sharing with employees the cost savings that this sustained wellness behavior produces. In other words, this aspect of the invention contemplates the notion of increasing rewards (or maybe increasing deduction credits) for wellness program participation for each successive time period, such as a year, that the employee participates in a given wellness category. For instance, a reward in a first year of tobacco cessation participation in a wellness program might be $200.00 for the first year and would increase by 10% by each subsequent year in the same manner as compound interest. For example, a person who has refrained from tobacco usage for three years, their third year reward would be $242.00. Whether these increasing amounts eventually achieve a ceiling, would be another employer choice. It is important to note, however, that the notion of increasing rewards, or increasing a magnitude of a withheld penalty, for wellness behavior with each subsequent time period, need not necessarily be tied to a state-governed fully-insured or HIPAA compliant health benefit plan as in the previous embodiments. For instance, an employer could simply provide financial rewards to employees that would be taxable income to the employee and a tax deduction to the employer for participation in a wellness program, and then increase those rewards with sustained participation in the wellness program. On the other hand, if an employee quits smoking for three years then starts smoking again, they would have to start out again at the base level if they again choose to cease smoking.

Those skilled in the art will appreciate that the present invention provides a number of ways to financially motivate employees to take behavioral steps to reduce the magnitude of, and frequency of, health related claims, and do so in a manner that decreases employer costs immediately and likely in a compounding fashion in the years to come.

It is preferred that all categories of wellness that trigger a financial consequence are implemented in a stepped fashion in response to measured biometrics of the individual employee, and preferably doing so on a renewal yearly or some other periodic basis. Viewed in percentage terms, preferably most, if not all of the steps are between about 10% and 20% of the total wellness variation possible. From a dollar perspective, preferably most, if not all of the steps would be between $100 and $1000, and more preferably between $200 and $500. While these dollar figures are based upon the value of the dollar at the Jul. 11, 2003, date of filing, it is to be understood that in considering the scope of claims referencing dollars, a corresponding adjustment shall be made based upon the changes in the Consumer Price Index of the U.S. Department of Labor, Bureau of Labor Statistics over time, or if that index ceases to exist, a corresponding index to account for changes in the value of the dollar for consumers (CPI). It was discovered that patients' health is improved by providing a meaningful step for each of multiple wellness categories when compared to incentives that are not parsed by wellness categories, or when compared to incentives that essentially do not have steps, and are designed to have an essentially continuous, non-stepped relationship with the wellness criteria. References to steps herein are not intended to include numerous small discrete changes over a range.

Among the biometrics that can be directly measured are body mass index, and blood pressure. A blood draw, or other bodily fluid, can permit measuring of a wide variety of biometrics indicative of the individual, including cholesterol levels, blood glucose levels and indicators of tobacco usage. In another aspect, all benefits for participation in wellness programs would be conditioned on the employee voluntarily permitting measurement of biometrics related to individual wellness categories. In a preferred embodiment, all benefits would be conditioned on the employee permitting height and weight measurements to be taken to determine a body mass index, permitting their blood pressure to be taken, and permitting a blood draw so that the biometrics identified above, and maybe others, could be measured. By measuring and displaying biometrics measured on an annual basis, employees can better understand and appreciate trends in biometrics that are directly related to their health and their lifestyle choices. For instance, by displaying in a single document an employee's yearly cholesterol levels, an employee can recognize trends in this health indicator, and maybe take appropriate actions to improve upon that biometric. On the other hand, an employee might be encouraged to take even more healthy lifestyle choices when they see that previously adopted healthier choices have improved upon one or more of their biometrics.

In another aspect of the invention, there is a recognition that an employee may have a biometric outside of a range that corresponds to a full deduction credit, but they may be taking actions to improve that biometric, and those actions may be deserving of some recognition. Thus, the present disclosure contemplates a variety of predetermined employee actions that would result in a partial credit to reduce their deductible. Each of the predetermined employee actions would be those that tend to improve a biometric associated with the wellness category. Thus, taking prescribed medication could be a predetermined employee action, participating in a smoking cessation program might be another, participating in a weight loss program or exercise program might be others, and finally, participation in a wellness education program might also earn the employee a partial deduction credit against an increase in the deduction resulting from the employer adopting a plan according to the present invention.

In still another aspect, the present disclosure recognizes that information relating to health biometrics of an individual, and yearly trends in the same, can be useful in assessing that individual's risk with regard to other insurance products. For instance, if a measured biometric or other information indicates that the employee is a smoker, one could expect that person to be at a higher risk of a home owners claim, possibly due to fire, and possibly an increased risk of automobile accidents due to smoking diverting attention from the road. In another instance, those with elevated blood glucose levels indicating a likelihood of future diabetes could expect to incur higher vision and dental related claims. In still another example, a person that is indicated as having a high body mass index could expect to have longer response times, and thus be at a higher risk of automobile accidents, and may be at an elevated risk for home-owners related claims as well. In addition, those with unhealthy biometrics might be expected to require longer hospital stays in the case of an automobile accident. Thus, in this aspect of the invention, an employee is rated with respect to a non-health insurance policy based upon a biometric of the type discussed above. For instance, if a biometric indicates tobacco usage, that individual could expect higher automobile insurance premiums, home owners insurance premiums and umbrella policy premiums. On the other hand, if a biometric indicates that a person is a non-smoker, they could expect reduced rates in both automobile and home owners insurance, and umbrella policy premiums. Non-health insurance policies according to this aspect of the disclosure include dental, vision, motor vehicle insurance, home owners insurance, and umbrella policies, for examples. Use of a biometric taken in association with a health benefit plan to impact rates of another non-health policy is a considerable cost savings from having duplicate testing, and may better provide incentives to healthy wellness practices than focusing only on health benefit plans unlinked to other policies. Thus, implementing the wellness program of the present invention can provide useful information in regard to other health insurance products.

From the forgoing, it will be appreciated by those skilled in the art that providing a benefit, or withholding a penalty, based on wellness conditions (such as can be identified with health biometrics), rather than based upon mere participation in a wellness program, can provide improved health and productivity among the covered individuals. For example, providing a benefit for joining a gym might provide a modest improvement in health, assuming that some people not only join but follow through to actually get more exercise. However, one might well expect such an incentive not to have a substantial long term impact on behavior. On the other hand, if the benefit is conditioned upon a verifiable health condition, such as resting heart rate, which is linked to and a substantial portion of the purpose of the behavior, then a more substantial and lasting improvement in health is achieved.

Those skilled in the art will appreciate that the above description is intended for illustrative purposes only, and is not intended to limit the scope of the present invention in any way. For instance, those skilled in the art will no doubt identify other ways in which individual choices and behavior can be assessed for the risk of a possible future claim, and a conditional benefit can be crafted to give an incentive to the employee to make healthier choices or engage in healthier behavior, or otherwise risk shouldering the financial burden for their unhealthy choices. In other words, the present invention seeks to better allocate the risk of, and magnitude of, healthcare claims to the choices and behavior that statistically tend to give rise to particular health related claims. While some of the discussion above refers to across the board deductible changes, one can also consider disease specific deductible changes linked to a specific aspect of a wellness program, or a combination of both. Likewise, the use of a deposit account as a supplemental policy, from which qualified health expenses, including deductibles and co-pays under the primary policy, can be paid can be incorporated into the invention as well. For example, the funding of the deposit account can be made a step function, based upon which wellness criteria have been met, with each of those being met triggering a specific quantity of funding for the deposit account. For example, just like step function changes to the deductable amount or premium levels warranted by meeting wellness criteria, you can fund a deposit account when wellness criteria are met. In all of these cases, a credit offset is effectively provided for the predetermined deductible

Thus, those skilled in the art will recognize many different ways in which a wellness program can be constructed according to the present invention beyond the illustrated examples discussed above, without departing from the scope of the invention as defined by the claims set forth below.

1. A process for physically transforming a person into a healthier person, the process comprising:
(a) covering the person under a health benefit plan having a predetermined deductible;
(b) drawing blood from the person;
(c) testing the blood to determine whether the person is within at least two wellness categories;
(d) for each of said wellness categories the person is determined to be within, providing a credit offset for the predetermined deductible, wherein at least two of the credits each individually constitute at least 10% of the total available credit;
(e) repeating at least steps (b) through (d).

2. The process of claim 1 additionally comprising:
The testing of blood in step c) additionally includes determining whether the person is within a third wellness category and
the providing a credit includes a third credit within the third wellness category in which said third credit individually constitutes at least 10% of the total credit.

3. The process of claim 1 in which said providing step provides that said at least two of the credits each constitute at least about 20% of the total available credit.

4. The process of claim 1 additionally comprising:
The testing of blood in step c) additionally includes determining whether the person is within a third wellness category and
the providing a credit includes a third credit within the third wellness category and in which each of the three credits individually constitute at least about 20% of the total credit.

5. The process of claim 1, wherein the repeating of at least steps (b) through (d) is done on a periodic basis.

6. The process of claim 5, wherein the repeating of at least steps (b) through (d) is done on an annual basis.

7. The process of claim 1, wherein the health benefit plan is an employee group health benefit plan, and further comprising performing steps (a) through (e) on more than one employee.

8. The process of claim 7, wherein the blood is tested to determine whether the employee is within a non-smoking wellness category, a healthy blood glucose wellness category, and a healthy cholesterol wellness category.

9. The process of claim 8, comprising the additional steps of:
(f) testing the person to determine whether they belong to a healthy blood pressure wellness category, and wherein step (f) is also repeated in step (e).

10. The process of claim 9, comprising the additional step of:
(g) measuring the person's weight;
(h) measuring the person's height;
(i) determining whether the person belongs to a healthy body mass wellness category; and wherein steps (g) and (i) are also repeated in step (e).

11. The process of claim 1, comprising the additional step of:
(g) measuring the person's weight;
(h) measuring the person's height;
(i) determining whether the person belongs to a healthy body mass wellness category; and wherein steps (g) and (i) are also repeated in step (e).

12. A process for making a person healthier, the process comprising:
(a) additionally covering a person covered under a primary group health benefit plan under a supplemental group health benefit plan having a predetermined deductible;
(b) ascertaining the person's height;
(c) measuring the person's blood pressure and determining whether they belong to a blood pressure wellness category;
(d) ascertaining the person's weight and determining whether they belong to a weight-related wellness category;
(e) for each of the employees determined to be within a blood pressure wellness category, providing a first credit;
(f) for each of the employees determined to be within a weight-related wellness category, providing a second credit;
(g) reducing the predetermined deductible by the amount of each of the credits provided in steps (e) and (f);
(h) repeating at least steps (c) through (g).

13. The process of claim 12, wherein the repeating of at least steps (c) through (g) is done on a periodic basis.

14. The process of claim 13, wherein the repeating of at least steps (c) through (g) is done on an annual basis.

15. A process for causing a set of employees to have statistically less and smaller healthcare related claims, the process comprising:
(a) covering the set of employees already covered under a primary group health benefit plan with a supplemental group health benefit plan having a predetermined deductible;
(b) drawing blood from each of the employees in the set;
(c) testing the blood to determine which employees belong to at least three wellness categories;
(d) for each of the wellness categories a given employee is determined to be within, providing a credit that reduces the predetermined deductible, wherein at least three of the credits each individually constitute at least 10% of the total available credit;
(e) repeating at least steps (b) through (d) and adjusting the credit available if there are changes in the results as to said at least three wellness categories.

16. The process of claim 15, wherein the amount of the credits provided for each of the wellness categories a given employee is determined to be within is equal.

17. The process of claim 16, further comprising the steps of:
(f) testing each of the employees in the set to determine whether they belong to a healthy blood pressure wellness category;
(g) testing each of the employees in the set to determine whether they belong to a wellness category that is based at least in part on weight; and
(h) considering the results of steps (f) and (g) in step (d), where each step determined to be within a wellness category, has an associated credits each individually constituting at least 10% of the total available credit; and
wherein steps (f), (g) and (h) are also repeated in step (e).

18. The process of claim 17, wherein the amount of the credits provided for each of the wellness categories a given employee is determined to be within is equal.

19. A process for making a person healthier, comprising the steps of:
(a) covering the person also covered under a primary health benefit plan under a supplemental health benefit plan having a predetermined deductible, the predetermined deductible being variable by a reduction of at least $200 for each of a predetermined set of wellness categories to which the person is determined to belong;
(b) testing the person to determine whether they belong to at least three of the wellness categories belonging to the predetermined set of wellness categories, and providing a step-wise reduction to the predetermined deductible for each category met.

20. The process of claim 19, wherein the testing of the person includes the following sub-steps:
(b)(1) drawing blood from the person;
(b)(2) testing the blood to determine whether the person belongs to one or more wellness categories.

21. The process of claim 19, wherein the testing of the person to determine whether they belong to at least three wellness categories includes the following sub-steps:
(b)(3) measuring the person's height;
(b)(4) measuring the person's weight.

22. The process of claim 19, wherein the testing of the person is periodically repeated, and wherein the step-wise reduction of the predetermined deductible is reevaluated in each period based on the results of the most recent testing.

23. The process of claim 19 in which the reduction to the deductible for each of the wellness categories all of equal value.

24. The process of claim 19 in which the reduction to the deductible is at least $400 in Jul. 11, 2003 dollars, adjusted by the Consumer Price Index, for at least one of the predetermined wellness categories.

25. The process of claim 19 in which the reduction to the deductible is at least $400 in Jul. 11, 2003 dollars, adjusted by the Consumer Price Index, for at least three of the predetermined wellness categories.

26. The process of claim 19 in which the reduction to the deductible is at least $500 in Jul. 11, 2003 dollars, adjusted by the Consumer Price Index, for at least one of the predetermined wellness categories.

27. The process of claim 19 in which the reduction to the deductible is at least $1000 in Jul. 11, 2003 dollars, adjusted by the Consumer Price Index, for at least one of the predetermined wellness categories.
